(19) United States
(12) Patent Application Publication
(10) Pub. No.: US 2010/0033034 A1
(43) Pub. Date: Feb. 11, 2010

(54) High-Power and High-Torque Step Motor

(76) Inventors: Chia-Ming Chang, Taichung (TW); Hsin-An Chiang, Taichung (TW)

Correspondence Address: Dr. BANGER SHIA, 102 Lindencrest Ct., Sugar Land, TX, 77479-5201, US

(21) Appl. No.: 12/189,153

(22) Filed: Aug. 9, 2008

(51) Int. Cl. H02K 37/04

(52) U.S. Cl. 310/49.45

(57) ABSTRACT

A high-power and high-torque step motor comprising a stator which is provided with a first stator pole, a second stator pole, a third stator pole, a fourth stator pole, a fifth stator pole, a sixth stator pole, a seventh stator pole and a eighth stator pole. An A-phase winding orderly winds around the first, third, fifth and seventh stator poles, and a B-phase winding orderly winds around the second, fourth, sixth and eighth stator poles. The first, second, fifth and sixth stator poles are wound in the same direction, and the winding direction of the third, fourth, seventh and eighth stator poles is opposite to that of the first, second, fifth and sixth stator poles. By such arrangements, the high-power and high-torque step motor is formed.

### BACKGROUND OF THE INVENTION

1. Field of the Invention

The present invention relates to a step motor which rotates by using magnetic field and electricity, and more particularly to a high-power and high-torque step motor which can obtain the optimal output efficiency by winding by using the optimal efficiency manner to change the winding coefficient and output reaction electromotive force of coils.

2. Description of the Prior Art

A conventional step motor rotates by the interaction of the electric field, the magnetic field, the movement or force moment, and the electric field is produced when the current passes through coils in the magnetic field. The electric field has an absolute relation to the performance of the step motor, and the rotation speed of the step motor can be controlled by changing the current passing through the coils or adjusting the peripheral electromagnetic intensity. However, how to improve the performance of the step motor while not changing the current and the original basic structure of the step motor has become an important issue for the manufacturers.

The step motor is widely used, and the quality of the step motor lies on the proportion of an input power to an output efficiency. The current step motor usually comprises a stator in which a rotor is disposed. The stator is formed with a stator outer diameter having a magnetic space, and in a periphery of the magnetic space is provided a plurality of stator poles that are spaced at intervals. The rotor cooperates with inner peripheries of the stator poles to rotate, and the coils wind around the stator poles. The electric field is produced when the current passes through the coils. The winding method of the coils wind around the stator poles has a relation to the produced electromagnetic intensity, and different winding methods will influence the performance of the step motor.

The winding methods of the coils wind around the stator poles of the current step motors has no definite principle, and the winding methods are different which completely give priority consideration to the convenience of winding and processing but not produce the optimal efficiency of the step motor, so that the copper loss and iron loss are high, and the output power of the step motor is influenced.

A winding method is described as follows: an A-phase winding firstly winds around a first stator pole in a clockwise direction, then winds around a third stator pole in a counterclockwise direction, and finally winds around a fifth stator pole and a seventh stator pole in a clockwise direction, respectively. A B-phase winding firstly winds around a second stator in a clockwise direction, then winds around a fourth stator pole in a counterclockwise direction, and finally winds around a sixth stator pole and a eighth stator pole in a clockwise direction, respectively. The formed winding coefficient is 0.353, and the step motor of such a winding method has a low efficiency.

Another winding method is described as follows: the A-phase winding orderly winds around the first, third, fifth and seventh stator poles in a clockwise direction, and the B-phase winding orderly winds around the second, fourth, sixth and eighth stator poles in a clockwise direction. The formed winding coefficient is 0.5, and the efficiency of the step motor of such a winding method is slightly higher than that of the above-mentioned winding method.

A further winding method is described as follows: the A-phase winding firstly winds around the first stator pole in a clockwise direction, then winds around the third stator pole in a counterclockwise direction, and finally winds around the fifth stator pole and the eighth stator pole in a clockwise direction, respectively. The B-phase winding firstly winds around the second stator in a clockwise direction, then winds around the fourth stator pole in a counterclockwise direction, and finally winds around a sixth stator pole and a seventh stator pole in a clockwise direction, respectively. The formed winding coefficient is 0.559, and the efficiency of the step motor of such a winding method is also slightly higher than that of the second winding method.

The present invention has arisen to mitigate and/or obviate the afore-described disadvantages.

### SUMMARY OF THE INVENTION

The technical problems that needed to be solved:

The winding methods of the coils wind around the stator poles of the current step motors has no definite principle and way, and the winding methods completely give priority consideration to the convenience of winding and processing, and cannot produce the optimal efficiency of the step motor, so how to improve the output power by using the same structure and input power is the technical problem that needed to be solved.

The technical characteristics for solving the problems:

The present invention is to provide a high-power and high-torque step motor which comprises a stator in which a magnetic space is provided, and in a periphery of the magnetic space is provided a first stator pole, a second stator pole, a third stator pole, a fourth stator pole, a fifth stator pole, a sixth stator pole, a seventh stator pole and a eighth stator pole that are spaced at intervals. An A-phase winding and a B-phase winding wind around the first, second, third, fourth, fifth, sixth, seventh and eighth stator poles. The A-phase winding orderly winds around the first, third, fifth and seventh stator poles, and the B-phase winding orderly winds around the second, fourth, sixth and eighth stator poles. The first, second, fifth and sixth stator poles are wound in the same direction, and the winding direction of the third, fourth, seventh and eighth stator poles is opposite to that of the first, second, fifth and sixth stator poles. By such arrangements, the high-power and high-torque step motor is formed.

The advantages of the present invention compared with the prior art:

The primary objective of the present invention is to provide a high-power and high-torque step motor, with the above-mentioned winding order and method, the first, second, third, fourth, fifth, sixth, seventh and eighth stator poles of the stator of the present step motor wound by the A-phase winding and the B-phase winding can increase the winding coefficient so as to improve the electromagnetic intensity in the magnetic space, and can change the reaction electromotive force, thus obtaining the high-efficiency and high-torque motor. Moreover, the present step motor can improve the output power by using the same input power, thus improving the efficiency of the step motor.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing stator poles of a high-power and high-torque step motor in accordance with the present invention;

FIG. 2 is an illustrative view showing the stator poles being wound by a A-phase winding in accordance with the present invention; and

FIG. 3 is an illustrative view showing the stator poles being wound by a B-phase winding in accordance with the present invention.

### DETAILED DESCRIPTION OF THE PREFERRED EMBODIMENTS

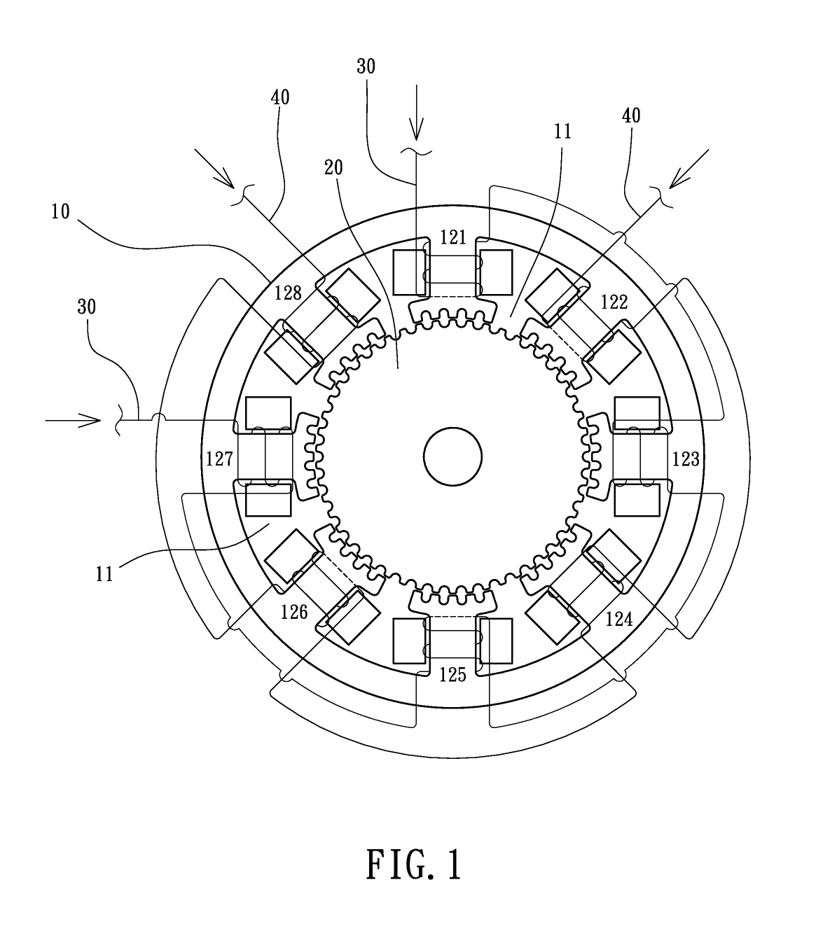

Referring to FIG. 1, a high-power and high-torque step motor in accordance with the present invention comprises a stator 10 and a rotor 20. The rotor 20 is disposed in the stator 10 and cooperates with the stator 10 to rotate. In the stator 10 is provided a magnetic space 11, and in a periphery of the magnetic space 11 is provided a first stator pole 121, a second stator pole 122, a third stator pole 123, a fourth stator pole 124, a fifth stator pole 125, a sixth stator pole 126, a seventh stator pole 127 and a eighth stator pole 128 that are spaced at intervals. An A-phase winding 30 and a B-phase winding 40 wind around the first, second, third, fourth, fifth, sixth, seventh and eighth stator poles 121, 122, 123, 124, 125, 126, 127 and 128.

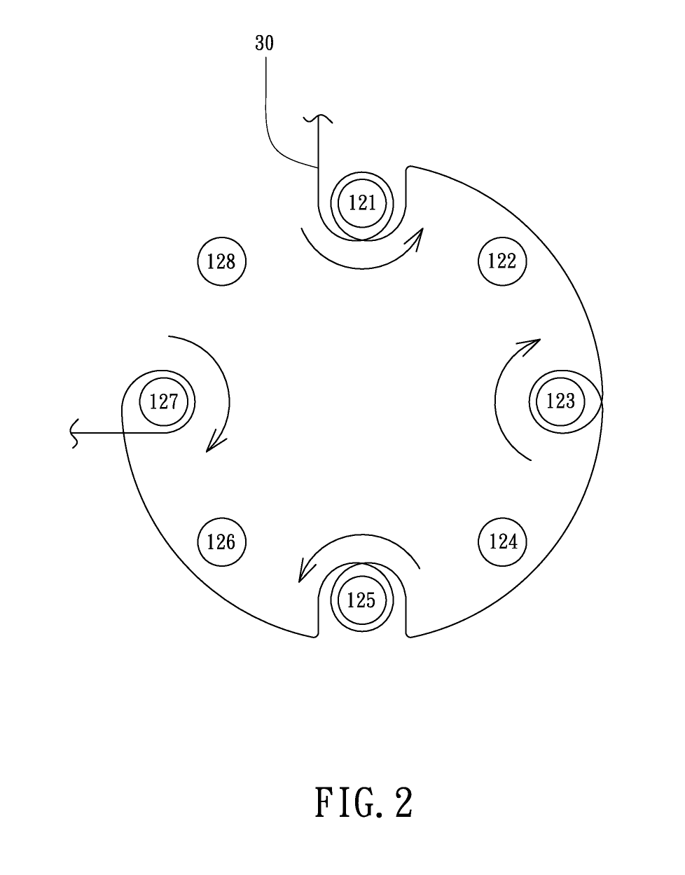

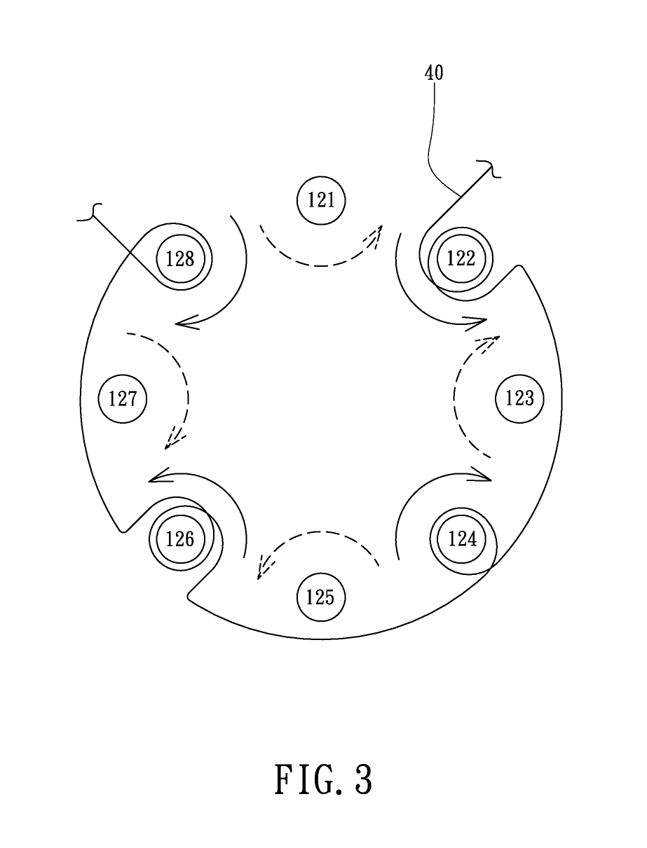

The A-phase winding 30 orderly winds around the first, third, fifth and seventh stator poles 121, 123, 125 and 127 as shown in FIG. 2, the A-phase winding 30 firstly winds around the first stator pole 121 in a counterclockwise direction, and then extends to the third stator pole 123 and winds around it in a clockwise direction, and further extends to the fifth stator pole 125 and winds around it in a counterclockwise direction, finally extends to the seventh stator pole 127 and winds around it in a clockwise direction. The B-phase winding 40 orderly winds around the second, fourth, sixth and eighth stator poles 122, 124, 126 and 128 as shown in FIG. 3, the B-phase winding 40 firstly winds around the second stator pole 122 in a counterclockwise direction, and then extends to the fourth stator pole 124 and winds around it in a clockwise direction, and further extends to the sixth stator pole 126 and winds around it in a counterclockwise direction, finally extends to the eighth stator pole 128 and winds around it in a clockwise direction.

With the above-mentioned winding order and method, the first, second, third, fourth, fifth, sixth, seventh and eighth stator poles 121, 122, 123, 124, 125, 126, 127 and 128 of the stator 10 of the present step motor wound by the A-phase winding 30 and the B-phase winding 40 can improve the electromagnetic intensity in the magnetic space 11, so as to obtain the high-efficiency and high-torque motor. After being wound by the A-phase winding 30 and the B-phase winding 40, a winding coefficient of the step motor is 0.6 to 0.8, and optimally to be 0.707. The winding coefficient is the value of a distribution coefficient multiplies to a pitch factor.

To summarize, the A-phase winding 30 orderly winds around the first, third, fifth and seventh stator poles 121, 123, 125 and 127, and the B-phase winding 40 orderly winds around the second, fourth, sixth and eighth stator poles 122, 124, 126 and 128. The first, second, fifth and sixth stator poles 121, 122, 125 and 126 are wound in the counterclockwise direction, and the third, fourth, seventh and eighth stator poles 123, 124, 127 and 128 are wound in the clockwise direction.

In addition, the first, second, fifth and sixth stator poles 121, 122, 125 and 126 can also be wound in the clockwise direction, at this time, the third, fourth, seventh and eighth stator poles 123, 124, 127 and 128 are wound in the counterclockwise direction, such arrangements can also obtain the above-mentioned effects.

It is apparent from the above-mentioned descriptions that the A-phase winding 30 orderly winds around the first, third, fifth and seventh stator poles 121, 123, 125 and 127, and the B-phase winding 40 orderly winds around the second, fourth, sixth and eighth stator poles 122, 124, 126 and 128. The first, second, fifth and sixth stator poles 121, 122, 125 and 126 are wound in the same direction, and the winding direction of the third, fourth, seventh and eighth stator poles 123, 124, 127 and 128 is opposite to that of the first, second, fifth and sixth stator poles 121, 122, 125 and 126. Such a winding method can increase the winding coefficient so as to improve the electromagnetic intensity in the magnetic space 11, and can change the reaction electromotive force, thus obtaining the high-efficiency and high-torque motor. Moreover, it is unnecessary to change current capacity and the original basic structure of the step motor, so that the present invention is low cost and is convenient to manufacture.

While we have shown and described various embodiments in accordance with the present invention, it should be clear to those skilled in the art that further embodiments may be made without departing from the scope of the present invention.

What is claimed is:

1. A high-power and high-torque step motor, comprising: a stator and a rotor, the rotor being disposed in the stator, in a periphery of the stator being provided eight stator poles that are spaced at intervals, that is, a first stator pole, a second stator pole, a third stator pole, a fourth stator pole, a fifth stator pole, a sixth stator pole, a seventh stator pole and a eighth stator pole, an A-phase winding and a B-phase winding wind around the stator poles, characterized in that:
the A-phase winding orderly winds around the first, third, fifth and seventh stator poles, the A-phase winding firstly winds around the first stator pole in one direction, then winds around the third stator pole in an opposite direction, further winds around the fifth stator pole in the one direction, finally winds around the seventh stator pole in the opposite direction, the B-phase winding orderly winds around the second, fourth, sixth and eighth stator poles, the B-phase winding firstly winds around the second stator pole in one direction, then winds around the fourth stator pole in an opposite direction, further winds around the sixth stator pole in the one direction, finally winds around the eighth stator pole in the opposite direction, a winding coefficient of the step motor which is wound by the A-phase and B-phase windings is 0.6 to 0.8.

2. The high-power and high-torque step motor as claimed in claim 1, wherein the A-phase winding winds around the first and fifth stator poles in a clockwise direction, winds wind the third and seventh stator poles in a counterclockwise direction, the B-phase winding winds around the second and sixth stator poles in a clockwise direction, and winds around the fourth and eighth stator poles in a counterclockwise direction.

3. The high-power and high-torque step motor as claimed in claim 1, wherein the A-phase winding winds around the first and fifth stator poles in a counterclockwise direction, winds wind the third and seventh stator poles in a clockwise direction, the B-phase winding winds around the second and sixth stator poles in a counterclockwise direction, and winds around the fourth and eighth stator poles in a clockwise direction.

4. The high-power and high-torque step motor as claimed in claim 1, wherein the winding coefficient of the step motor is 0.707 optimally.
